(19) United States
(12) Patent Application Publication
(10) Pub. No.: US 2010/0231524 A1
(43) Pub. Date: Sep. 16, 2010

(54) Icon/text interface remote controller

(76) Inventor: Stephen Chen, Shengang Shiang (TW)

Correspondence Address: Guice Patents PLLC, 12647 Galveston Court #302, Manassas, VA, 20112, US

(21) Appl. No.: 12/073,800

(22) Filed: Mar. 10, 2008

(51) Int. Cl. G06F 3/041; G06F 1/32

(52) U.S. Cl. 345/173; 713/323

(57) ABSTRACT

An icon/text interface remote controller and particularly a remote controller incorporating with a display device which displays an icon/text menu interface to allow users to make selection mainly includes a touch panel, a button switch, a power supply, a power control circuit and a wireless emission circuit that incorporate with the display device. Users can see options of the icon/text menu on the display device to do remote control operation in a more user-friendly fashion.

### BACKGROUND OF THE INVENTION

1. Field of the Invention

The present invention relates to an icon/text interface remote controller and particularly to a remote controller incorporating with a display device to allow users to directly see options of an icon/text menu on the display device to do remote control operation in a more user-friendly fashion.

2. Description of the Prior Art

Most conventional electronic products nowadays provide remote control function to facilitate user operation. Hence performing remote operation through a remote controller becomes a mandatory function of many electronic products. As the functions of electric devices become more complicated and versatile, such as DVD, MP3 music players, vehicle navigation, digital TV and the like, multiple functions are increasingly popular. Thus the number of buttons on the remote controller also increases. Some of them are composite keys. Namely one button provides different functions in different conditions. This makes operation of the remote controller more complicated. Users have to spend a lot of time to learn operations. And most users can use only a small portion of functions that are simpler.

The viewing window interface on computers also provides complicated functions, but is much easier to learn for users. This is because the computer viewing window interface has an icon/text interface. Through a mouse cursor icon functional items on the screen can be selected. In some occasions when the cursor is moved to an icon option a text description appears to enable users to familiarize the operation even easier without much trials and errors.

Moreover, as the computer is very popular these days, most people are familiar with operation of the computer icon interface. To make operation of electric devices like computer operation will greatly boost user friendliness.

### SUMMARY OF THE INVENTION

Therefore it is an object of the present invention to provide an icon/text interface remote controller, and particularly a remote controller incorporating with a display device to allow users to do selection and operation through a displayed icon/text menu interface. The remote controller according to the invention mainly includes a touch panel, a button switch, a power supply, a power control circuit and a wireless emission circuit that incorporate with a display device. Thus users can see options of an icon/text menu on the display device to do remote control operation in a more user-friendly fashion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a schematic view of an embodiment of the invention.

FIG. 3 is a schematic view of an embodiment of the button switch of the invention.

### DESCRIPTION OF THE PREFERRED EMBODIMENTS

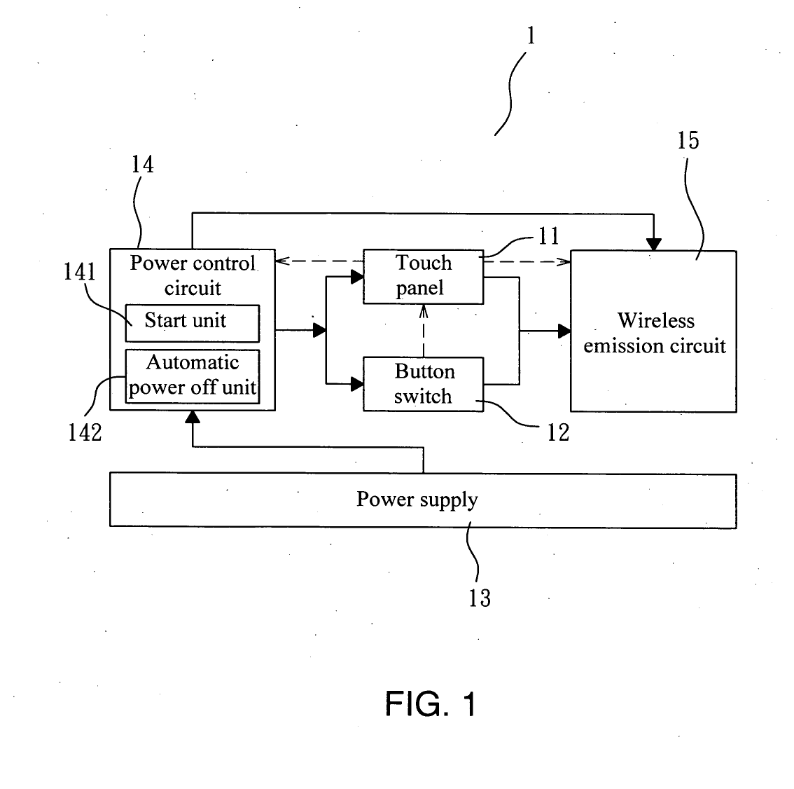

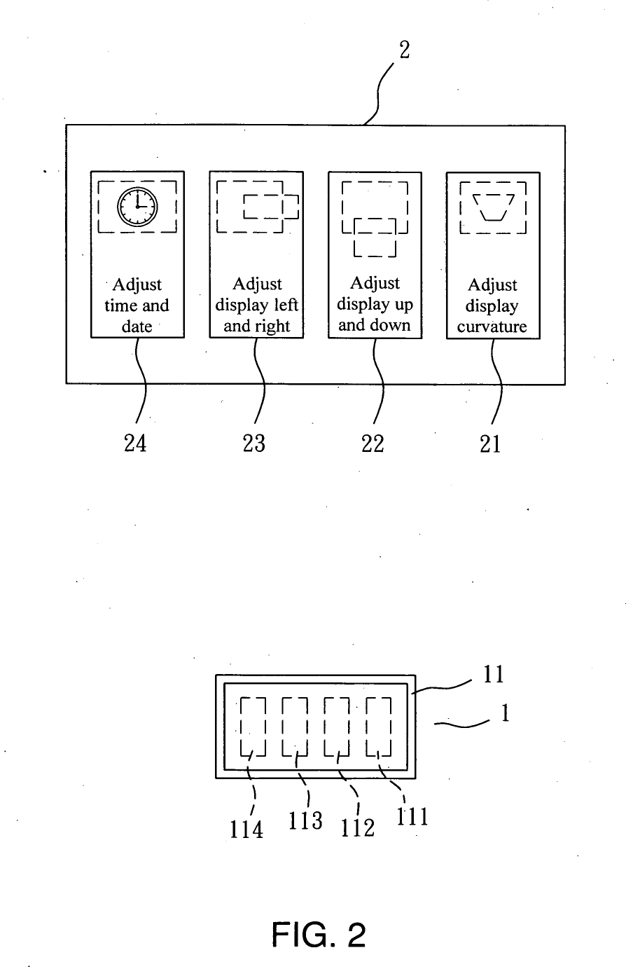

Referring to FIGS. 1 and 2, the icon/text interface remote controller 1 according to the invention mainly includes a touch panel 11, a button switch 12, a power supply 13, a power control circuit 14 and a wireless emission circuit 15 that incorporate with a display device 2.

The touch panel 11 detects touch and position of user's fingers in response to system operation. The touch panel 11 may be divided through a system into segments corresponding to options on the display device 2.

The button switch 12 aims to execute depressed input function.

The power supply 13 has one or more battery to provide electric power.

The power control circuit 14 has at least one start unit 141 and one automatic power off unit 142. The start unit 141 allows users to activate the power supply 13 when the icon/text interface remote controller 1 is in a regular power-saving condition. By depressing the button switch 12 the start unit 141 is activated. The activation also can be triggered by depressing the touch panel 11 for a period of time. The automatic power off unit 142 aims to shut down the power supply 13 after the icon/text interface remote controller 1 is not being used for a selected duration.

The wireless emission circuit 15 aims to issue commands related to the position coordinates of the touch panel 11 where user's finger makes contact and depressing of the button switch 12. It may be an infrared emission circuit, a FM/AM emission circuit or a Bluetooth emission circuit.

Referring to FIG. 2, by means of the construction set forth above, the segments 111, 112, 113 and 114 of the touch panel 11 are corresponding to icon/text options 21, 22, 23 and 24 displayed on the display device 2. Hence a user can touch the segments 111, 112, 113 and 114 on the touch panel 11 with a finger corresponding to the options 21, 22, 23 and 23 on the display device 2 to choose the options 21, 22, 23 and 24, and depress the button switch 12 to confirm the selection. Thus there is no need to search required setting on the remote controller. By seeing the displayed icon/text on the display device operation can be set in an interactive fashion.

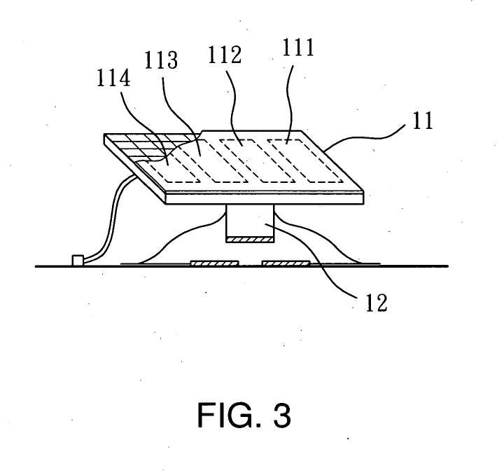

Referring to FIG. 3, the button switch 12 is located beneath the touch panel 11. The touch panel 11 can be depressed to trigger the button switch 12.

As a conclusion, through the icon/text controlled options users can perform remote control operation in a user-friendly manner to shorten the time of trials and errors. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An icon/text interface remote controller comprising mainly a touch panel, a button switch, a power supply, a power control circuit and a wireless emission circuit that incorporate with a display device; wherein:
the touch panel detects touch and position of user's fingers in response to system operation, and is divided through a system into segments corresponding to options on the display device;
the button switch executes depressed input function;
the power supply provides electric power required by the icon/text interface remote controller;
the power control circuit has at least one start unit and one automatic power off unit; and
the wireless emission circuit issues commands related to position coordinates of the fingers on the touch panel and depressing of the button switch.

2. The icon/text interface remote controller of claim 1, wherein the button switch is located beneath the touch panel to be activated when the touch panel is depressed.

3. The icon/text interface remote controller of claim 1, wherein the start unit is activated by depressing the button switch.

4. The icon/text interface remote controller of claim 1, wherein the start unit is activated by depressing the touch panel for a selected duration through the fingers.

5. The icon/text interface remote controller of claim 1, wherein the wireless emission circuit is an infrared emission circuit.

6. The icon/text interface remote controller of claim 1, wherein the wireless emission circuit is a FM emission circuit.

7. The icon/text interface remote controller of claim 1, wherein the wireless emission circuit is an AM emission circuit.

8. The icon/text interface remote controller of claim 1, wherein the wireless emission circuit is a Bluetooth emission circuit.

9. The icon/text interface remote controller of claim 1, wherein the automatic power off unit shuts down the power supply after the remote controller is not being used for a selected time period.

10. The icon/text interface remote controller of claim 1, wherein the power supply has batteries to provide the electric power.
